(19) United States
(12) Patent Application Publication
(10) Pub. No.: US 2015/0053620 A1
(43) Pub. Date: Feb. 26, 2015

(54) WATER TREATMENT

(71) Applicant: Temple University of the Commonwealth System of Higher Education, Philadelphia, PA (US)

(72) Inventors: Rominder P.S. SURI, Audubon, PA (US); Dan LIU, Blue Bell, PA (US)

(21) Appl. No.: 14/465,719

(22) Filed: Aug. 21, 2014

Related U.S. Application Data
(60) Provisional application No. 61/868,152, filed on Aug. 21, 2013.

(51) Int. Cl. C02F 1/28; C02F 1/42

(52) U.S. Cl. CPC C02F 1/285; C02F 1/42; C02F 2001/422; C02F 2101/305
USPC 210/670; 210/692; 210/683

(57) ABSTRACT

The present invention features compositions and methods for reducing the concentration of an endocrine disrupting agent in an aqueous solution. We describe compositions comprising various polymeric resins. The methods can be used to reduce the concentration of endocrine disrupting agents, including estrogens, perfluorinated compounds and bisphenol A in an aqueous solution.

### CROSS REFERENCE TO RELATED APPLICATIONS

This application claims the benefit of the filing date of U.S. Provisional Application No. 61/868,152 which was filed on Aug. 21, 2013. For the purpose of any U.S. application that may claim the benefit of U.S. Provisional Application No. 61/868,152, the contents of that earlier filed application is hereby incorporated by reference in its entirety.

### FIELD OF THE INVENTION

The present invention relates to relates to water treatment, and more particularly, to methods of reducing the levels of endocrine disrupting agents in aqueous solutions.

### BACKGROUND OF THE INVENTION

Increasingly, emerging contaminants of concern (ECCs), for example, pharmaceuticals, personal care products, perflourinated chemicals (PFCs) and others, have been detected in the natural environment. ECCs have been found in locations, particularly in water, where they had not been previously found or have been found at higher levels than in the past. Many ECCs are known to be endocrine disrupting agents. Endocrine disrupting agents can interfere with the body's own endocrine system and produce adverse developmental, reproductive, neurological, and immune effects in both humans and animals. ECCs are not routinely monitored and their discharge into the environment is typically unregulated. Although most ECCs are present at very low concentrations, there is increasing public concern over potential human health and environmental implications. The existing conventional municipal wastewater treatment plants (WWTPs) are not designed to remove the ECCs. These compounds can enter the environment from point sources such as municipal WWTPs or industrial discharges, and non-point sources. Many drinking water intake points are located downstream of point sources. In many parts of the world, water shortages have made water reuse an attractive and even necessary option. There is a continuing need for the development and implementation of technologies that effectively remove ECCs from water and wastewater.

### SUMMARY OF THE INVENTION

The present invention provides methods of reducing the concentration of an endocrine disrupting agent in an aqueous solution. The method includes (a) providing an aqueous solution; (b) contacting the aqueous solution with a polymeric resin in an amount and for a time sufficient to substantially bind the agent to the resin. The method further includes the step of separating the contacted aqueous solution from the polymeric resin. The aqueous solution can be waste water. The endocrine disrupting agent can be an estrogen, a perfluorinated compound, or bisphenol A (4,4′-(propane-2,2-diyl)diphenol). In some embodiments, the estrogen is selected from the group consisting of 17α-ethynyl estrodial, estriol, 17β-estrodiol, 17α-estrodiol, estrone, 17α-dihydroequilin, trimegestone, medrogestone, progesterone, norgestrel, gestodene, and equilin. In some embodiments, the perfluorinated compound is selected from the group consisting of perfluorotridecanoic acid, tricosafluorododecanoic acid, perfluoroundecanoic acid, perfluorodecanoic acid, perfluorooctanoic acid tridecafluorononanoic acid, perfluoroheptanoic acid, undecafluorohexanoic acidheptadecafluorooctanesulfonic acid potassium salt, and tridecafluorohexane-1-sulfonic acid potassium salt. In some embodiments, salts of chloride, nitrate, sulfate, and carbonate may be present with the perfluorinated compound in aqueous solution. In some embodiments, the endocrine disrupting agent is bisphenol A. The concentration of the endocrine disrupting agent in the aqueous solution can be from about 1 ng/L to about 1000 ug/L, from about 1 ug/L to about 500 ug/L, or is about 100 ug/L. The polymeric resin can be a macroporous resin, a microporous resin or an adsorbent, or any combination thereof. The polymeric resin can have a mean pore diameter (D50) of about 15 Å to about 1000 Å. In some embodiments, the polymeric resin is an ion exchange resin. The ion exchange resin can be selected from the group consisting of a weak base anion exchange resin, a strong base anion exchange resin, a weak acid anion exchange resin, a strong acid anion exchange resin, or a combination thereof. The ion exchange resin comprises a functional group selected from the group consisting of a tertiary amine, a quaternary ammonium group, a bifunctional quaternary amine, and a carboxylic acid or salt thereof. The polymeric resin comprises a polystyrene matrix or a polymethacrylic matrix. The polymeric resin comprises a bead. In some embodiments, the contacting step comprises flowing the aqueous solution through a packed bed comprising the polymeric resin. The flow rate is from about 3 mL/min to about 50 mL/min and the contacting time is from about 8 hours to about 60 hours. In on embodiment, the contacting time is about 48 hours. The temperature of the resin is about 20° C. to about 40° C. In some embodiments, the concentration of the endocrine disrupting agent can be reduced to less than about 1 part per billion (ppb) to less than about 100 parts per million (ppm). In some embodiments, the concentration of the endocrine disrupting agent can be reduced to less than about 1 part per billion (ppb) to less than about 1 ppm. Also provided is a method of reducing the concentration of an endocrine disrupting agent in an aqueous solution, the method comprising: (a) providing an aqueous solution; (b) contacting the aqueous solution with a polymeric resin in an amount and for a time sufficient to substantially adsorb the agent to the resin.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 shows the structures of MN100 and MN200 hyper-cross-linked polymeric resins.

FIG. 2 is a table summarizing the structures and properties of the estrogen-disrupting compounds.

FIG. 3 is a graph depicting the results of an experiment comparing the adsorption of 17β-estradiol to MN100, MN200, A530E, A532E and C115 resins.

FIGS. 4 (a), (b), (c), and (d) are graphs depicting the depicting the results of an experiment comparing the effect of resin dosage on adsorption of estrogen hormones to MN100 and MN 200 resins.

FIGS. 5 (a), (b), (c), and (d) are graphs depicting the results of an experiment comparing the effect of contact time on adsorption of estrogen hormones to MN100 and MN200 resins.

FIG. 6a is a graph depicting the results of an experiment comparing the effect of pH on adsorption of estrogen hormones to MN100 resin. FIG. 6b is a graph depicting the results of an experiment comparing the effect of pH on adsorption of estrogen hormones to MN200 resin.

FIGS. 7 (a), (b), and (c) are graphs depicting the results of an analysis of a fixed-bed column study on the adsorption of estrogen hormones to MN100 resin.

FIG. 8 is a graph depicting the results of an experiment comparing the adsorption of perfluorooctanoic acid (PFOA) to MN100, MN200, A530E, A532E and C115 resins.

FIG. 9 is a graph depicting the results of an experiment analyzing the effect of PFOA concentration on PFOA adsorption to A530E, A532E and MN100 resins.

FIG. 10 is a graph depicting the depicting the results of an experiment comparing the effect of resin dosage on adsorption of PFOA to A530E, A532E and MN100 resins.

FIG. 11a is a graph depicting the results of an experiment comparing the effect of contact time on adsorption of PFOA to A530E, A532E, and MN100 resins using an initial PFOA concentration of 29.51 μg/L. FIG. 11b is a graph depicting the results of an experiment comparing the effect of contact time on adsorption of PFOA to A530E, A532E, and MN100 resins using an initial PFOA concentration of 60.06 μg/L.

FIG. 12 (a), (b), (c), (d), (e), and (f) are graphs depicting the depicting the results of an experiment comparing the effect of resin dosage on adsorption of PFC's to A532E, A530E and MN100 resins.

FIG. 13 is a graph depicting the results of an experiment comparing the adsorption of bisphenol A (BPA) to MN100, MN200, A530E, A532E and C115 resins.

FIG. 14 is a graph depicting the depicting the results of an experiment comparing the effect of resin dosage on adsorption of BPA to MN100 and MN200 resins.

FIG. 15 a graph depicting the results of an experiment comparing the effect of contact time on adsorption of BPA to MN100 and MN200 resins.

FIG. 16 is a graph depicting the results of an experiment comparing the effect of pH on adsorption of BPA to MN100 and MN200 resins.

FIG. 17 is a graph depicting the results of an experiment comparing the regeneration tests for MN100 and MN200 resins.

FIG. 18 is a graph depicting the results of an experiment comparing the adsorption of 1,4-dioxane to MN100, MN200, A530E, A532E and C115 resins.

FIG. 19 is a graph depicting the results of an analysis of adsorption isotherm of boron on S 108 resin.

FIG. 20 is a table of experimental details for the adsorption of boron on to S108 resin.

FIG. 21 is a graph depicting the results of an experiment determining breakthrough curve for Boron removal in MQ water in column experiments using S108 resin.

FIG. 22 is a graph depicting the results of an analysis of the adsorption isotherm of PFOA on to A532E resin.

FIG. 23 is a graph depicting the results of an analysis of the adsorption isotherm of PFOS on to A532E resin.

FIG. 24 is a table of experimental details for the adsorption of PFOA and PFOS on to A532E resin in the presence of anions.

FIG. 25 is a graph depicting the results of an experiment determining the breakthrough curve for PFOA and PFOS removal in MQ water in column experiments using A532E resin.

FIG. 26 is a graph depicting the results of an experiment determining the breakthrough curve for PFOA and PFOS removal in MQ water in column experiments using A532E resin at higher bed volumes.

FIG. 27 is a table of experimental details for the adsorption of PFOA and PFOS on to A532E resin.

FIG. 28 is a graph depicting the results of an experiment determining the breakthrough curve for PFOA and PFOS removal in MQ water in column experiments using A532E resin in the presence of various anions.

FIG. 29 is a graph depicting the results of analysis of influent and effluent concentration of anions with the perfluorinated compounds in the column-format experiment.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures.

The present invention is based in part in the inventors' discovery that certain polymeric resins effectively bind endocrine disrupting agents. Accordingly, the invention features methods and compositions that can be used to remove endocrine disrupting agents from aqueous solutions. The methods are useful for treatment of a wide range of aqueous solutions and in many locations, including, for example, municipal waste water facilities, factories, laboratories, and hospitals.

### Compositions

The compositions disclosed herein comprise a polymeric resin. The polymeric resin can be a spherical bead. The structure and functionality of the resin can vary. In some embodiments, the resin can be a hypercrosslinked polystyrene. Useful hypercrosslinked polystyrene resins include the Hypersol-Macronet® resins (Purolite® International). These polymers are derived from a spherical styrene-divinyl benzene copolymer that is crosslinked while the polymer is in a swollen state. The Macronet® resins have a high surface area (1000-1500 m²/g) which confers a high adsorption capacity. These resins comprise both macropores, for example, pores having a mean diameter (D₅₀) of about 850-950 Å and micropores, for example, pores having a mean diameter (D₅₀) of about 15 Å. An exemplary Macronet® resin is MN200, which a pore volume of 1-1.1 mL/g and a surface area of 800-1000 m²/g.

In some embodiments, the polymeric resins can also include a functional group, for example, an ion exchange moiety. Ion-exchange is a reversible chemical reaction in which ions from a solution are exchanged for similarly charged ions attached to an immobile solid particle. Ion exchange resins are typically highly ionic, covalently cross-linked, insoluble polyelectrolytes supplied as beads. The beads can have either a dense internal structure with no discrete pores (gel resins, also called microporous resins) or a porous, multichannelled structure (macroporous or macroreticular resins). They are commonly prepared from styrene and the cross-linking agent divinyl benzene which controls the porosity of the particles. Macroporous resins, with their high effective surface area, facilitate the ion exchange process, give access to the exchange sites for larger ions, can be used with almost any solvent, and are more rigid beads, facilitating ease of removal from the reaction system. Microporous resins have no discrete pores, so solute ions diffuse through the particle to interact with exchange sites. These resins are less fragile than macroporous resins, react faster in functionalization and applications reactions, and possess higher loading capacities.

The ion exchange moiety can be a weak base anion exchange group, a strong base anion exchange group, a strong acid anion exchange group or an weak acid anion exchange group. In some embodiments, the weak base anion exchange group can be a tertiary amine. Another exemplary Macronet® resin is the MN100 resin (Purolite®) has a tertiary amine ion exchanger, a pore volume of 1-1.1 mL/g and a surface area of 800-1000 m²/g.

In some embodiments, the polymeric resin can be a macroporous resin. Macroporous resins were developed to improve kinetics by providing a highly porous copolymer bead matrix for ion exchange with relatively large pore size improves diffusion of chemical species into the interior portions of the beads. Macroporous resins contain significant non-gel porosity in addition to normal gel porosity. This non-gel porosity arises from channels present between the gel lattices. These microscopic channels are separate and distinct from the micropores, which are present in all cross-linked ion exchange resins, as is well known to those skilled in the art. Ion exchange resins generally have bead diameters within about 150-1,200 μm.

Various macroporous resins and methods for generating macroporosity are known in the art. The terms “macroporous,” “macroreticular,” “sponge-like,” and “channeled” have been used, more or less interchangeably, by those skilled in the art to characterize the hazy to completely opaque beads and resins. “Pore-forming,” “phase-separating,” “precipitant,” and “porogen” have all, likewise, been used to refer to the agent used to produce the macroporous structure. Other types of resins can also be used, including but not limited to Sepharose, Sephadex, Amberlite products, and cross-linked polyacrylamide-based resins.

The capacity of the macroporous resin is defined as how many H+ ions can be exchanged per one mass and/or volumetric unit of resin. The capacity is given as either dry weight capacity or volume capacity. The dry weight capacity is indicated as equivalents per kilogram (eq/kg) or equivalently as milliequivalents per g (meq/g) of dry resin and the volume capacity is indicated as equivalents per one liter of fully swollen resin (eq/l). The actual dry weight capacity for many resins is well below the theoretical maximum. An exemplary macroporous resin is Purolite® A530E, a macroporous strong base anion resin crosslinked with divinylbenzene that is selective for hydrophobic anions. The functional group can be a quaternary ammonium.

In some embodiments, the polymeric resin can be a microporous or “gel-type” resin. An exemplary microporous resin is Purolite® A532E, a dual quarternary amine bifunctional resin that exhibits selectivity for hydrophobic anions.

In some embodiments the polymeric resin can be a porous polymethacrylic resin. An exemplary porous polymethacrylic resin is Purolite® C115, a weak acid carboxylic cation exchange resin in the hydrogen form. Another exemplary resin is Purolite® S110, a weak amine resin that exhibits selectivity for boron. Another examplary resin is Purolite® S108 resin, a weak amine resin that exhibits selectivity for boron. Another exemplary resin is Purolite® A532E, a strong amine resin.

### Methods

The compositions disclosed herein are generally and variously useful for reducing the concentration of endocrine disrupting agents in an aqueous solution.

The structure of the endocrine disrupting agent can vary. An endocrine disrupting agent can be a small molecule, a complex or a polymer that interferes with the body's endocrine system. A wide range of substances, both natural and man-made, are thought to cause endocrine disruption, including pharmaceuticals, dioxin and dioxin-like compounds, polychlorinated biphenyls, DDT and other pesticides, and plasticizers such as bisphenol A. Endocrine disruptors may be found in many everyday products—including plastic bottles, metal food cans, detergents, flame retardants, food, toys, cosmetics, and pesticides.

Endocrine systems, also referred to as hormone systems, are found in all mammals, birds, fish, and many other types of living organisms. Endocrine systems include glands, hormones released by those glands, and receptors in various organs and tissue that respond to those hormones. Disruption of the endocrine system can occur in various ways. Some endocrine disrupting agents mimic a natural hormone, causing an over-response to the stimulus (e.g., a growth hormone that results in increased muscle mass), or responding at inappropriate times (e.g., producing insulin when it is not needed). Other endocrine disrupting agents block the effects of the native hormone. Still others directly stimulate or inhibit the endocrine system and cause overproduction or underproduction of hormones (e.g. an over or underactive thyroid). Certain drugs are used to intentionally cause some of these effects, such as birth control pills. In many situations involving environmental chemicals, however, an endocrine effect is not desirable.

An endocrine disrupting agent can be an estrogen, including, for example, without limitation, 17α-ethynyl estrodiol, estriol, 17β-estrodiol, 17α-estrodiol, estrone, 17α-dihydroequilin, trimegestone, medrogestone, progesterone, norgestrel, gestodene, and equilin. In some embodiments the estrogen can be a xenoestrogen, including for example, phthalates, alkylphenols, polychlorinated biphenyls, and polybrominated diphenyl ethers. Estrogens can also include naturally occurring phytoestrogens such as genistein and mycoestrogens such as zearalenone. Trace levels of endocrine disrupting agents have been detected all around the world. Certain estrogenic compounds such as 17β-estradiol (at concentration of low ng/L) can cause endocrine disrupting effects in fish species such as trouts, minnows and estuarine flounders.

An endocrine disrupting agent can be a perfluorinated compound, for example, perfluorotridecanoic acid, tricosafluorododecanoic acid, perfluoroundecanoic acid, perfluorodecanoic acid, perfluorooctanoic acid, tridecafluorononanoic acid, perfluoroheptanoic acid, undecafluorohexanoic acid, heptadecafluorooctanesulfonic acid potassium salt, and tridecafluorohexane-1-sulfonic acid potassium salt. Perfluorinated compounds (PFCs) are used as surface protectors of textile, carpet, paper repelling water and oil and they are released to the environment primarily during the manufacturing and coating process.

Salts can also be present with the perfluorinated compound. For example, salts of chloride, nitrate, sulfate, and carbonate can be present at concentrations of milli-equivalents of the perfluorinated compound. The resins can remove the perfluorinated compound in the presence of the salts.

An endocrine disrupting agent can be bisphenol A. Bisphenol A (BPA) is produced worldwide. It is typically used as a monomer for the production of polycarbonate and epoxy resins. The release of BPA into the environment is believed to occur during manufacturing processes and by leaching from finished products.

Other exemplary endocrine disrupting agents include polychlorinated dibenzo-dioxins (PCDDs) and -furans (PCDFs), polycyclic aromatic hydrocarbons (PAHs), phenol derivatives, organochlorine insecticides such as endosulfan, Kepone (chlordecone) and DDT and its derivatives, the herbicide atrazine, and the fungicide vinclozolin), and the cyclic ether 1,4-dioxane. 1,4-dioxane is used as a solvent stabilizer in various products such as paints and lacquers and in processes such as organic chemical manufacturing.

Regardless of the type of polymeric resin and the particular endocrine disrupting agent, the resins can be used to treat any aqueous solution comprising or suspected to comprise an endocrine disrupting agent. The aqueous solutions can include waste water, drinking water, or water used in industrial and laboratory applications. It is to be expected that the concentration of any particular endocrine disrupting agent may be quite low, but the invention is not so limiting. Exemplary concentration ranges include from about 1 ng/L to about 1000 ug/L, for example about 10 ng/L, about 100 ng/L, about 500 ng/L, about 1 ug/L, about 10 ug/L, about 100 ug/L, about 500 ug/L. The time of contact between the polymeric resin and the aqueous solution may also vary, for example from about 8, about 10, about 12, about 14, about 16, about 18, about 20, about 24, about 30, about 36, about 48, about 54 or about 72 hours. The efficiency of removal can be assayed using any art-know method, for example, UPLC/MS (ultra performance liquid chromatography-mass spectrometry), UPLC/MS/MS ultra performance liquid chromatography-mass spectrometry-mass spectrometry), or UPLC/UV or any combination thereof (ultra performance liquid chromatography-ultraviolet detection). Other non-limiting methods to detect the efficiency of removal can be employed, for example, conductivity, electrophoretic mobility, capillary electrophoresis, HPLC (high performance liquid chromatography), ICP-MS (inductively-coupled plasma-mass spectroscopy), and IEX (ion-exchange chromatography). Following treatment, the concentration of the endocrine disrupting agent in the aqueous solution can be reduced by about 10%, about 20%, about 30%, about 40%, about 50%, about 60%, about 70%, about 80%, about 90%, about 95%, about 98%, about 99%, about 100% relative to the initial concentration. In some embodiments the final concentration of the endocrine disrupting agent in the aqueous solution can be less than about 1 part per billion (ppb), 2 ppb, 10 ppb, 100 ppb, 1 part per million (ppm), 10 ppm, 100 ppm.

The aqueous solution is contacted with the polymeric resin under conditions that substantially bind the endocrine disrupting agent to the resin. For example, an endocrine disrupting agent is substantially bound or substantially adsorbed when at least or about 60% of the endocrine disrupting agent by weight (e.g., at least or about 65%, 70%, 80%, 90%, 95%, 99%, or 100%) in the aqueous solution is bound to the polymeric resin.

In one embodiment, the resin can be packed into a fixed bed. Alternatively or in addition, a batch process can be used. The aqueous solution can be contacted with the polymeric resin as described in the examples or using art know methods.

For a fixed bed process, the liquid is preferably passed through at a predetermined rate. Feed rates can vary according to amount of estrogen disrupting agents, the degree of purification required for the particular liquid, the temperature, and the resin used. The feed rate can be between 0.5 to 50 bed volumes per hour. In another embodiment, the feed rate is 5 to 15 bed volumes per hour. The flow rate can be about 3-50 mL/min. The resin bed may optionally be graded by back-flushing before use.

Any suitable temperature may be used during the treatment process. Suitable temperatures are those below the temperature limit for the resin. Exemplary temperatures include about 20° C., about 35° C. about 50° C. and 80° C. In one embodiment, the temperature is approximately room temperature.

In some embodiments, various parameters of the aqueous solution may be adjusted in order to maximize the efficiency of removal of a particular compound. These parameters can include, for example, the pH, the ionic strength, the contact time, the resin dosage, the initial concentration of the aqueous solution, and the temperature. For example, increasing the solution pH from acidic to over pH 10 decreased the adsorption capacity for estrogens by the MN100 and MN200 resins. This decrease is consistent with the pH-dependent dissociation of estrogens and surface charge of the polymeric resins.

Without wishing to be bound by any theory, it appears that physical adsorption may be the primary mechanism of action for removal of estrogens, whereas ion exchange may be the primary mechanism for removal of PFCs with A530E, A532E, S108, S110, and MN100 resins.

The aqueous solution may be passed through another purification bed before and/or after removal of estrogen disrupting agent using the method described herein. Optionally, the aqueous solution may be passed through two or more resin beds. In some embodiments, the aqueous solution may be subjected to other treatment modalities either before or after contacting it with the polymeric resins described herein. For example, the aqueous solution may be subjected to standard water treatment processes, for example, sedimentation, filtration, disinfection, aeration, coagulation, hydrocyclonication, or flocculation. In some embodiments, other treatment methods can also be applied, including ozonization, advanced oxidation, nanofiltration and reverse osmosis.

In some embodiments, the ion exchange resin may be regenerated using standard art-know methods, for example, by washing the polymeric resin in methanol or alkaline solutions or high salt concentration solutions.

### EXAMPLES

### Example 1

### Materials and Methods

Chemicals and Reagents:

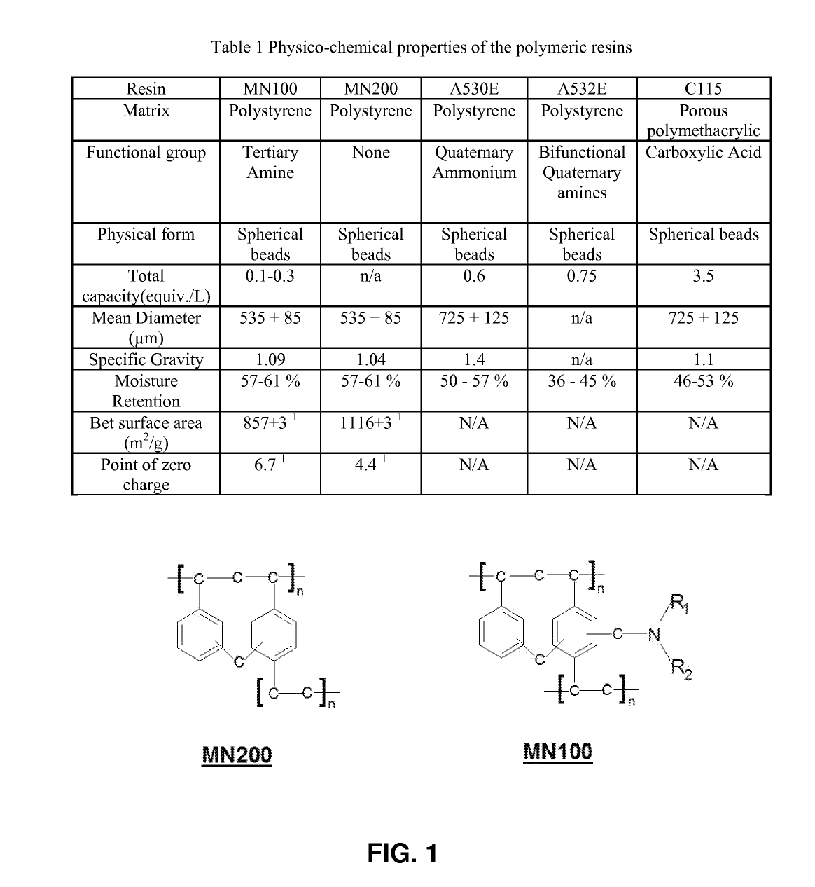

Seven polymeric resins (MN100, MN200, C115, S108, S110, A530E and A532E) were obtained from Purolite Co. USA. The physcio-chemical properties of the polymeric resins used in this study are listed in FIG. 1, Table 1A and in Table 1B shown below.

TABLE 1B
Physico-chemical properties of polymeric resins

Resin

| | S108 | S110 |
|---|---|---|
| Type | Macroporous Anion | Macroporous Anion |
| Physical Form | Spherical beads | Spherical beads |
| Functional Group | N-methylglucamine | N-methylglucamine |
| Ionic Form | Free base | Free base |
| Total Capacity | 0.6 | 0.8 |
| (eq/L) | | |
| Moisture | 61-67 | 40-50 |
| Retention % | | |

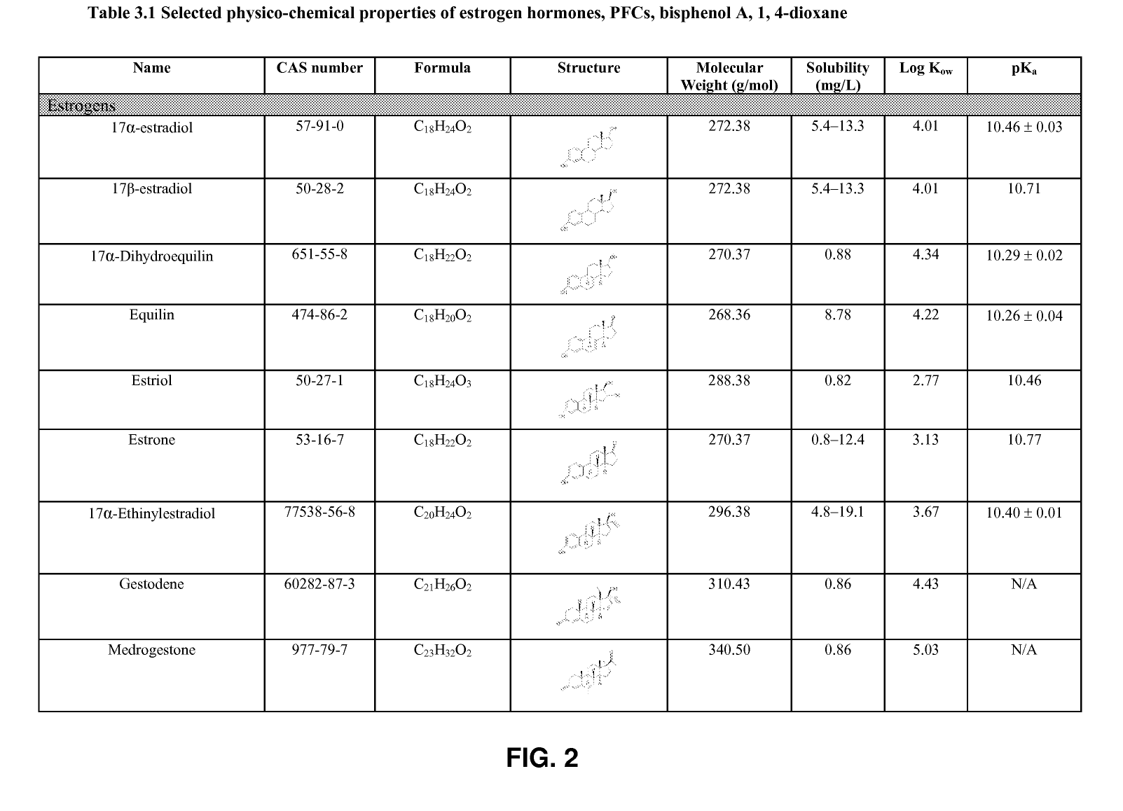

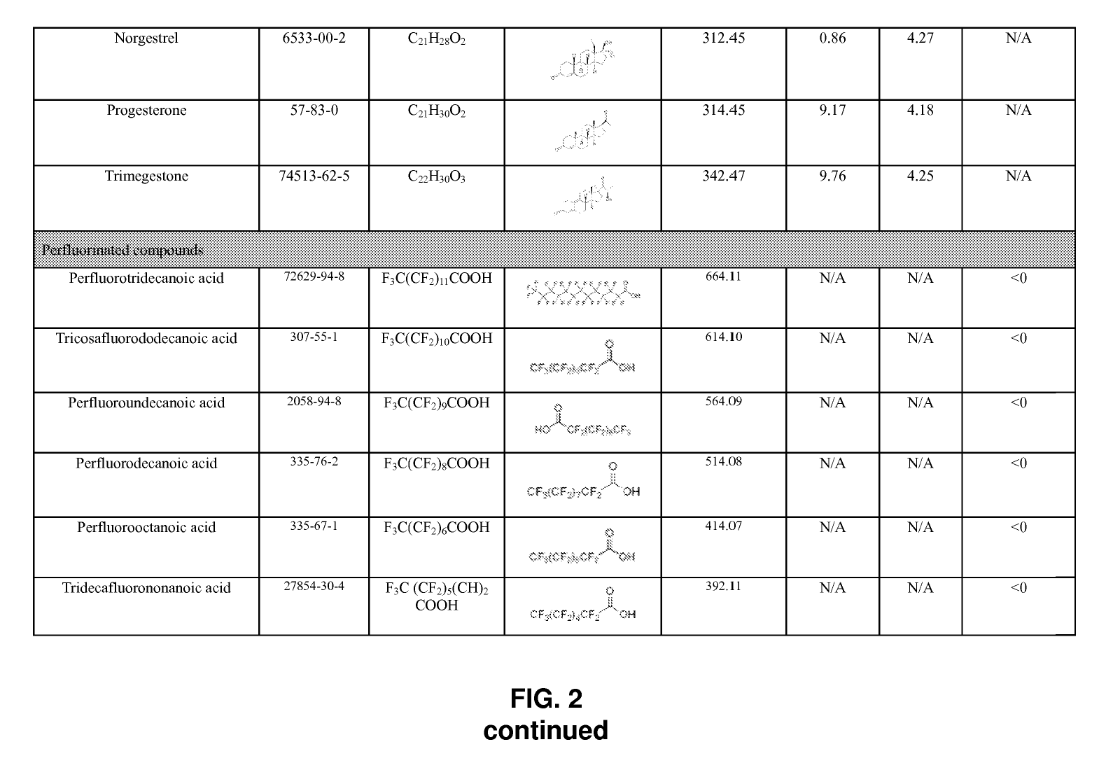

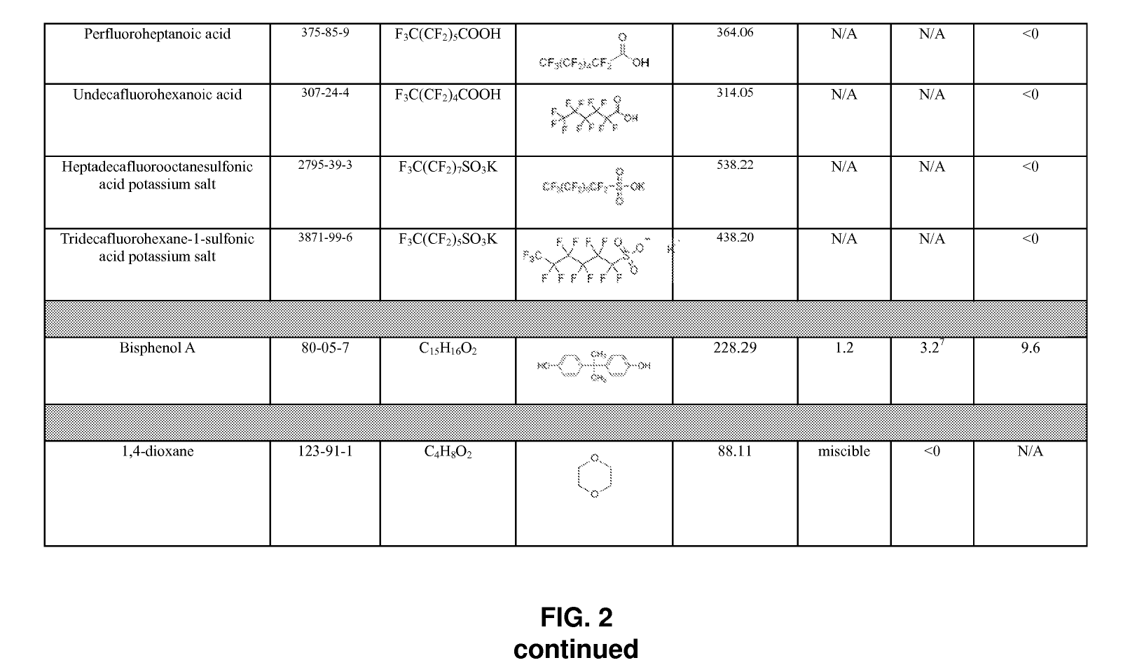

The structures of MN 100 and MN 200 hyper-cross-linked polymeric resins are shown in FIG. 1. Estrogens, Perfluorochemicals (PFCs) Bisphenol-A, and 1,4-dioxane were also purchased from Sigma-Aldrich (St. Louis, Mo.). The structures of the ECs used in this study are shown in FIG. 2. Glass chromatography columns were purchased from Ace Glass Inc (Vineland, N.J.). Unless otherwise specified, estrogen hormones were obtained from Sigma-Aldrich.

Resin Preparation:

Prior to use, 20 gram of the resin was weighed in a beaker, about 100 g of deionized water was added, and mixed slowly for about 15 minutes. The mixing was stopped and the resin was allowed to settle, and the water was decanted. These steps were repeated three times. Any residual water was removed using a Büchner funnel system (or a vacuum suction system), for 15 minutes or until no visual dripping of water was observed. The dewatered resin was placed in a container with sealed cap, and was used as needed.

Batch Experiments:

Batch adsorption experiments were carried out in series of 1 L amber bottles, containing 1 L or 500 mL working solution with ECs in Milli-Q water. The polymeric resins were added into these bottles and shaken at 175 rpm on a thermostatic shaker at temperature of 295 K. The amount of ECs adsorbed on the ion-exchange resins was calculated by using the following Equation 1:

$${q}_{e} = \frac{{C}_{0} - {C}_{e}}{M / V} \qquad Equation 1$$

Column Experiments:

In the column studies have, model solutions of ECs with concentration of 100 μg/L were prepared in the carboys, and then pumped in the column continuously. Model solutions were replaced periodically and the changes of initial concentrations were noted. Samples were taken at different times until breakthrough was observed. Flow rate was checked randomly to ensure the constant experimental conditions. Column conditions for MN 100 are shown in Table 2.

TABLE 2
Column conditions for removal of estrogen hormones

| Resin MN100 | Values |
|---|---|
| Target individual estrogen hormone concentration (μg/L) | 100 |
| Flow rate (ml/L) | 32 |
| Column diameter (cm) | 1.1 |
| Resin mass (g) | 1.5 |
| Bulk density (g/cm³) | 0.53 |
| Bed depth (cm) | 3 |
| EBCT (min) | 0.1 |
| Run time (h) | 52 |
| Temperature (K) | 295 |
| pH | 7.0 |

Analysis:

Solid phase extraction (SPE) was performed if the concentration of the samples were below the detection limits. Briefly, an aliquot of water sample (200-400 ml) was passed through the SPE column at a flow rate of 5 ml/min. After the sample was passed through the SPE column, the column was rinsed with Milli-Q water and then eluted with 6 ml of methanol. Methanol was dried in the evaporator and 1.5 ml of methanol, 1.5 ml of water was added and vortexed. 2 ml of sample was then collected in a silanized LC vial and analyzed on UPLC/MS/MS. The analysis of estrogen hormones, PFCs, BPA was also performed by direct injection of the samples into UPLC/MS/MS. The concentration of 1,4-dioxane was analyzed on GC/MS/MS.

### Example 2

### Screening Various Polymeric Resins for 17β-Estradiol Adsorption

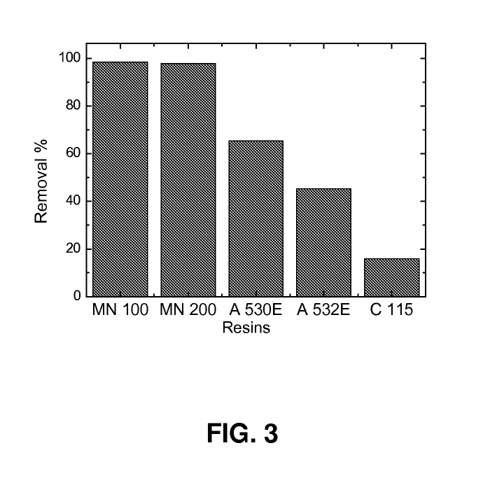

Resins MN100, MN200, A530E, A532E and C115 were assayed for the ability to adsorb 17β-estradiol as described in Example 1. Binding conditions were: initial concentration=134.74 μg/L, pH=7.0, contact time=48 hours, sample volume=1000 ml, temp=295 K, resin dosage=0.3 g/L. As shown in FIG. 3, MN100 and MN200 resins removed almost 100% of 17β-estradiol. A530E, A532E and C115 resins were less efficient than the MN100 and MN200 resins. MN100 and MN200 were selected for further analysis.

### Example 3

### Effect of Resin Dosage on the Removal of Estrogen Hormones

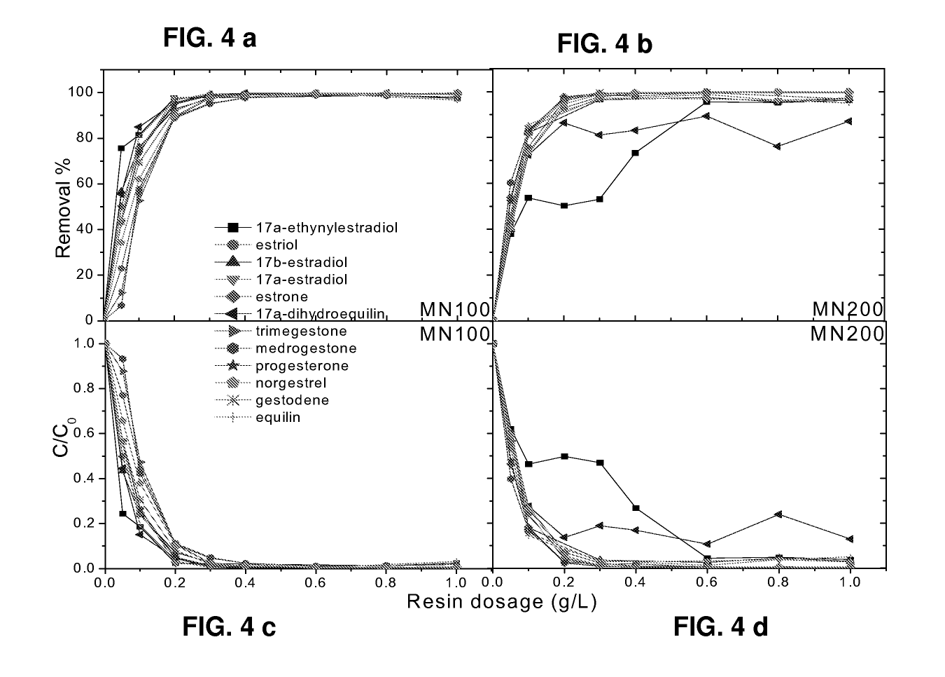

In order to identify the optimum resin dosage on the removal of estrogen hormones, resin dosage was varied from 0.05 to 1.0 g/L as described in Example 1 and as follows: target initial concentration=100 μg/L, pH=7.0, contact time=48 hours, sample volume=1000 ml, temp=295 K. A mixture of 12 estrogen hormones was applied to the resins: 17α-ethynyl estrodial, estriol, 17β-estrodial, 17α-estrodial, estrone, 17α-dihydroequilin, trimegestone, medrogestone, progesterone, norgestrel, gestodene, and equilin. As shown in FIG. 4, at 0.4 g/l, both MN 100 and MN 200 resins showed 99% removal of estrogen hormones. MN100 was more efficient for removal of 17β-ethynyl estradiol and 17α-dihydroequilin that was MN 200, which may reflect the different in surface properties of the two resins. We concluded that 0.4 g/l of resin dosage was found to be optimum dosage for effective estrogen removal.

### Example 4

### Effect of Contact Time on the Removal of Estrogen Hormones

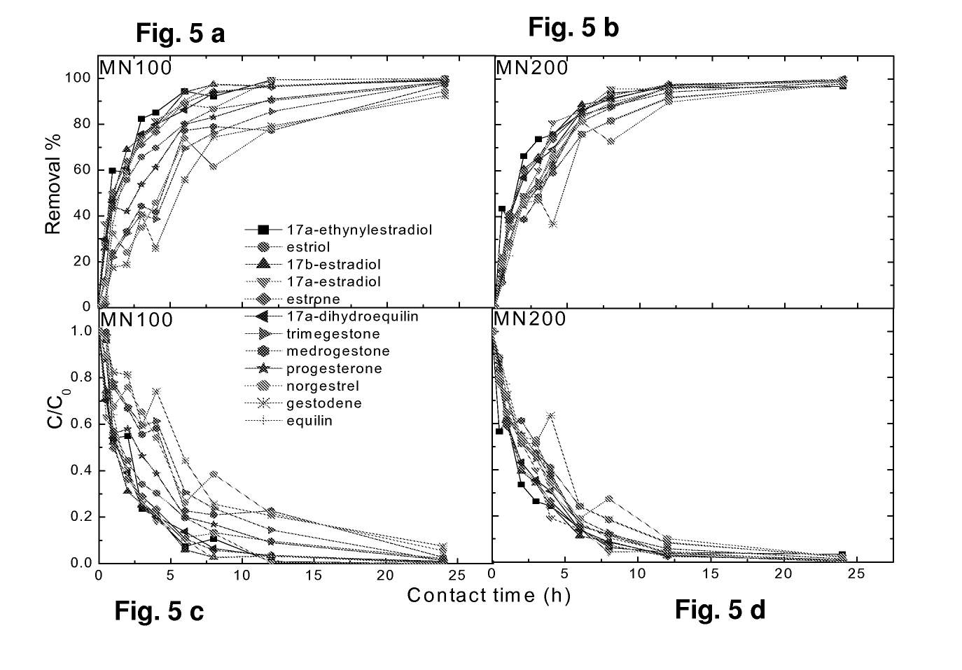

We tested the effect of contact time on efficiency of estrogen removal as described in Example 1 and as follows: target initial concentration=200 μg/L, resin dosage=0.2 g/L, pH=7.0, sample volume=1000 ml, temp=295 K. The mixture of estrogen hormones was as described in Example 3. The results of this experiment are shown in FIG. 5. The adsorption of five estrogens: trimegestone, progesterone, gestodene, medrogestone and norgestrel was relatively slower than that of the others on both MN 100 and MN 200. The molecular weights of these five compounds are greater than those of the other estrogens, which may account for their less efficient adsorption. Adsorption efficiency for MN 200 was higher than that of MN 100 which could be due to difference in their surface area. As noted in Example 1, MN200 resin has a higher surface area (1116±3 m²/g) than does MN 100 (857±3 m²/g) resin. All estrogens used in this experiment were in undissociated form under our experimental conditions.

### Example 5

### Effect of pH on the Removal of Estrogen Hormones

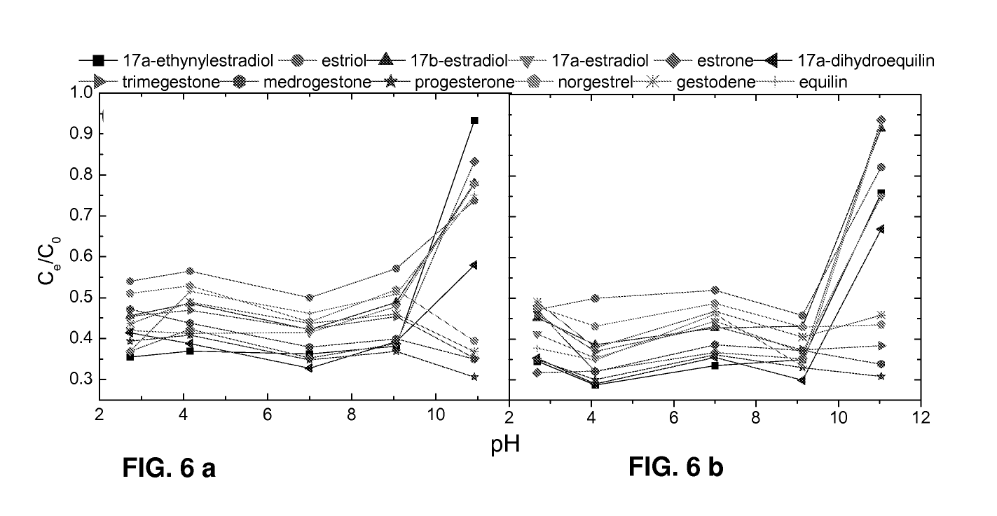

We tested the effect of pH on efficiency of estrogen removal as described in Example 1 and as follows: target initial concentration=200 μg/L, resin dosage=0.2 g/L, contact time=48 hours, sample volume=1000 ml, temp=295 K. The mixture of estrogen hormones was as described in Example 3. The results of this experiment are shown in FIGS. 6a and 6b. MN100 and MN200 resins clearly sorted the estrogen hormones into two categories: (a) those hormones for which adsorption efficiencies remained the relatively similar as pH increased from 2 to 11 (trimegestone, progesterone, gestodene, medrogestone and norgestrel); (b) those hormones for which adsorption efficiencies remained relatively similar as pH increased from 2 to 9 but then decreased as pH increased from 9 to 11 (17α-ethinylestradiol, estriol, 17β-estradiol, 17α-estradiol, estrone, 17α-dihydroequilin and equilin). This difference in adsorption efficiency may reflect pH-related changes in both the dissociation of the certain estrogen hormones and the surface charge of the resins.

### Example 6

### Fixed-Bed Column Study on the Removal of Estrogen Hormones

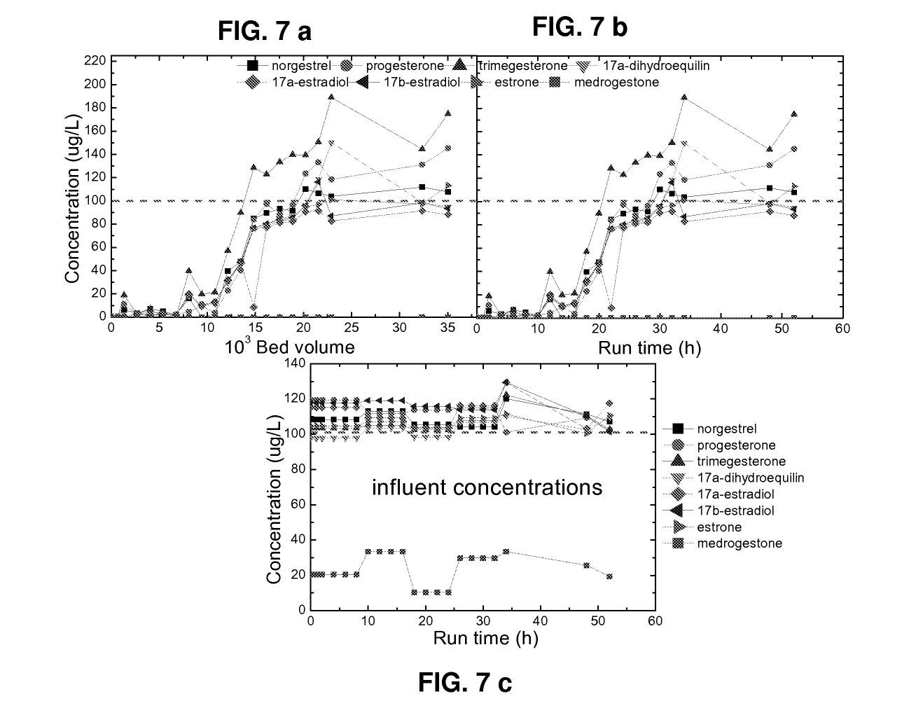

We analyzed the performance of the MN 100 resin on a fixed-bed column experiment as described in Example 1. The mixture of estrogen hormones was as described in Example 3. The main column conditions are summarized in Table 1. The results are shown in FIG. 7. As can be seen from FIG. 7, all the estrogen hormones were adsorbed on to MN100 resin in the first 10 hours (around 7000 bed volumes). Breakthrough points for all the estrogens were observed except for medrogestone. Trimegestone was the first estrogen detected in the effluent, followed by progesterone, norgestrel, 17α-dihydroequilin, estrone, 17α-estrodial and 17β-estrodial. The elutions of 17α-estrodial and 17β-estrodial were simultaneous due to their similar structures. The results indicate that trimegestone was least efficiently adsorbed onto the resin, while 17α-estrodial and 17β-estrodial were strongly adsorbed onto the resin.

### Example 7

### Screening Various Polymeric Resins for Perfluorooctanoic Acid (PFOA) Adsorption

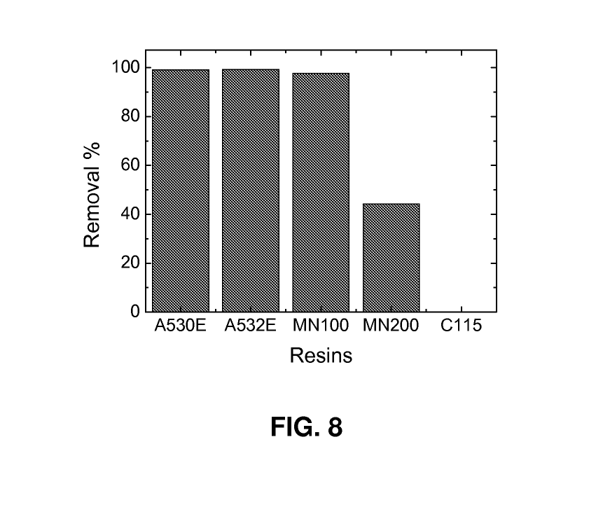

Resins MN100, MN200, A530E, A532E and C115 were assayed for the ability to adsorb perfluorooctanoic acid (PFOA) as described in Example 1 in batch mode. Binding conditions were: initial concentration=25.65 μg/L, pH=7.0, contact time=48 hours, sample volume=1000 ml, temp=295 K. As shown in FIG. 8, resins A530E, A532E and MN100 removed almost 99% of PFOA. MN 200 removed about 45% and C115 was not effective. We selected A530E, A532E and MN100 for further analysis.

### Example 8

### Effect of Initial Concentration of PFOA on PFOA Adsorption

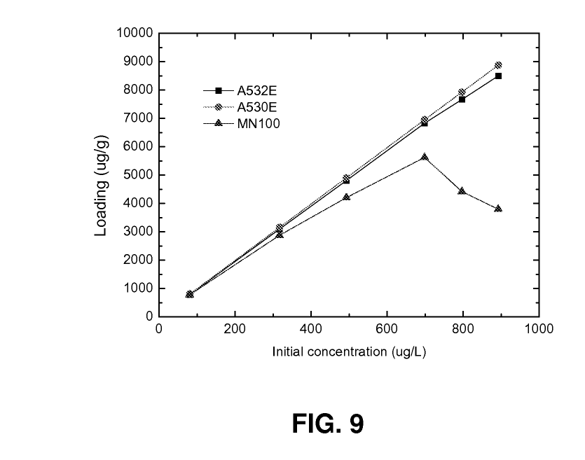

We tested the effect of PFOA concentration on PFOA adsorption as described in Example 1 and as follows: pH=7.0, contact time=48 hours, sample volume=1000 ml, temp=295 K. As shown in FIG. 9, as the initial concentration of PFOA increased from 100 μg/L to 900 μg/L, the loading capacities of A530E and A532E resins increased linearly. At initial concentration of 900 μg/L, A532E and A530E resins showed loading capacities of 8.5×10³ and 8.8×10³ μg/g, respectively, and the maximum adsorption capacities for A532E and A530E were still not reached (no equilibrium). For the MN100 resin, as the initial PFOA concentration increased from 100 μg/L to 700 μg/L, the loading capacity of MN100 resin increased, but then declined at initial PFOA concentrations above 700 μg/L. These data suggested that the MN100 resin had reached its adsorption capacity. As shown in FIG. 9, the maximum adsorption capacity of MN100 resin in the removal of PFOA was 5.6×10³ μg/g at initial concentration of 700 μg/L.

### Example 9

### Effect of Resin Dosage on the Removal of PFOA

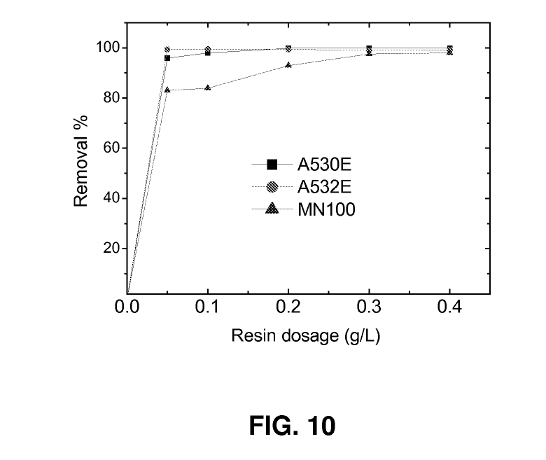

In order to identify the optimum resin dosage on the removal of estrogen hormones, resin dosage was varied from 0.05 to 0.4 g/L as described in Example 1 and as follows: initial concentration=54.29 μg/L, pH=7.0, contact time=48 hours, sample volume=1000 ml, temp=295 K. As shown in FIG. 10, at a resin dosage of 0.05 g/L, both A530E and A532E resins for A530E and A532E resins removed 99% of PFOA. At the same dosage, MN 100 removed 80% of PFOA. At a dosage of 0.4 g/L, all three resins removed 100% of PFOA was removed from aqueous solutions.

### Example 10

### Effect of Contact Time on the Removal of PFOA

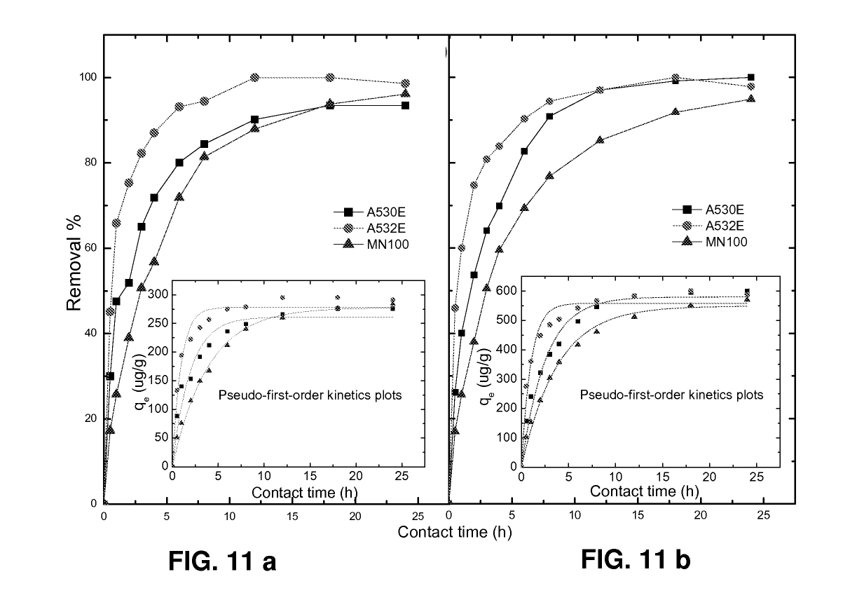

We tested the effect of contact time on efficiency of PFOA removal as described in Example 1 and as follows: pH=7.0, sample volume=1000 ml, temp=295K). The effect of contact time was evaluated by conducted the adsorption test under batch conditions for 52 hours. The results of this experiment are shown in FIGS. 11a and 11b. A532E and A530E resins yielded faster PFOA removal rates than did MN100. All three resins removed more than 97% PFOA after 52 hours with the initial concentration of 50 μg/L. The PFOA removal appeared to follow a pseudo-first-order kinetic model.

### Example 11

### Effect of Resin Dosage on the Removal of PFCs

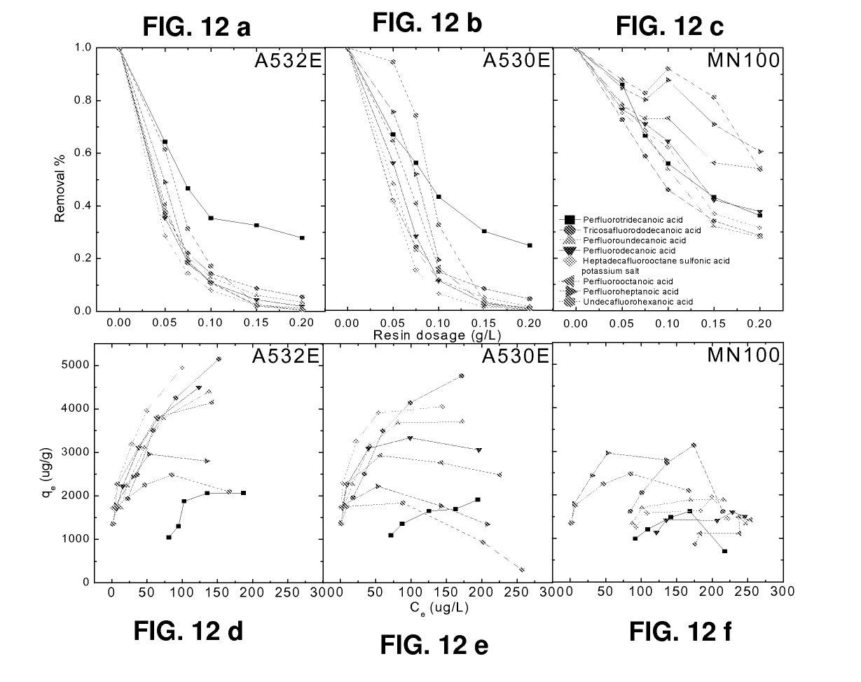

In order to identify the optimum resin dosage on the removal of PFC's, resin dosage was varied from 0.05 to 0.2 g/L as described in Example 1 and as follows: target initial concentration=300 μg/L, pH=7.0, contact time=48 hours, sample volume=1000 ml, temp=295 K. As shown in FIGS. 12a and 12b, at a resin dosage of 0.15 g/L, both A530E and A532E resins removed more than 90% of PFC's except for perfluorotridecanoic acid. At the same dosage, MN 100 removed less than 70% of PFCs. These results indicated that the removal of PFCs was an ion-exchange process since A530E and A532E resins are anionic ion-exchange resins.

### Example 12

### Screening Various Polymeric Resins for Bisphenol A (BPA) Adsorption

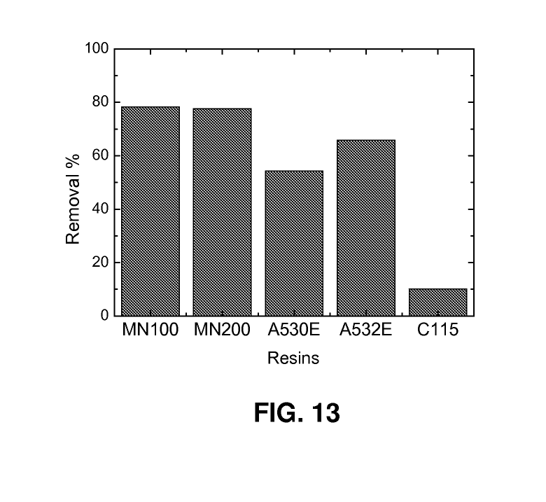

Resins MN100, MN200, A530E, A532E and C115 were assayed for the ability to adsorb bisphenol A (BPA) as described in Example 1 in batch mode. Binding conditions were: initial concentration=86.67 μg/L, pH=7.0, contact time=48 hours, sample volume=400 ml, temp=295 K, resin dosage=0.2 g/L. As shown in FIG. 13, resins MN100 and MN200 removed about 80% of BPA. A532E removed about 70%. We selected MN100 and MN200 for further analysis.

### Example 13

### Effect of Resin Dosage on the Removal of BPA

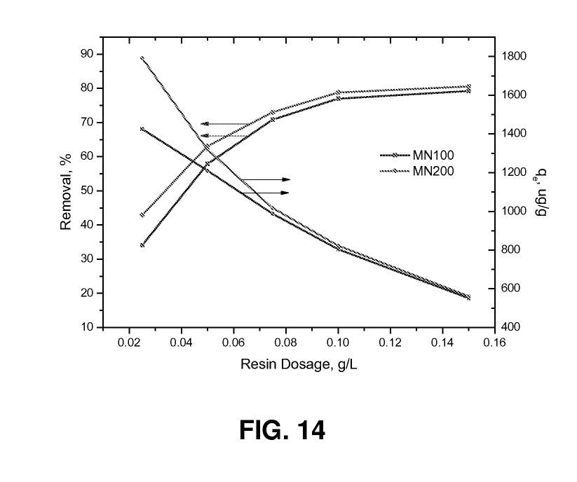

In order to identify the optimum resin dosage on the removal of BPA resin dosage was varied from 0.025 to 0.15 g/L as described in Example 1 and as follows: (initial concentration=104.4 μg/L, pH=7.0, contact time=48 hours, sample volume=400 ml, temp=295 K. As shown in FIG. 14, at a resin dosage of 0.15 g/L, both MN 100 and MN 200 resins removed about 80% of BPA. As resin dosage increased, the removal percentage also increased. However, the amount of BPA adsorbed per gram of resin decreased.

### Example 14

### Effect of Contact Time on the Removal of BPA

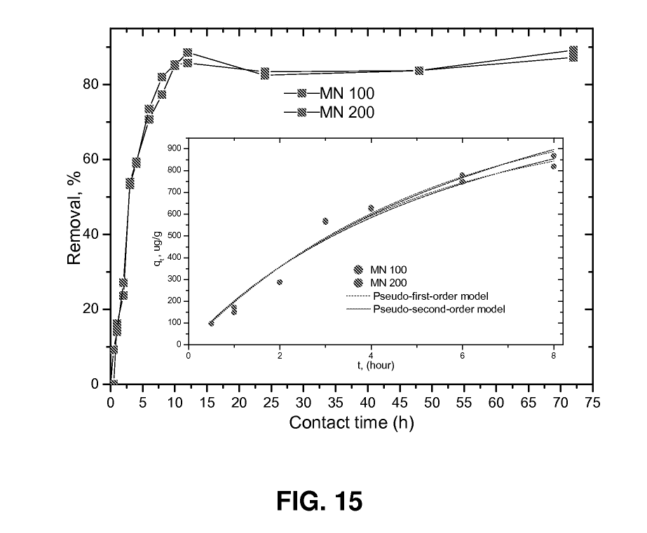

We tested the effect of contact time on efficiency of BPA removal as described in Example 1 and as follows: initial concentration=105.9 μg/L, pH=7.0, contact time=72 hours, sample volume=1000 ml, temp=295 K, resin dosage=0.2 g/L. The effect of contact time was evaluated by the adsorption test under batch conditions for 72 hours. The results of this experiment are shown in FIG. 15. Adsorption equilibrium was reached in 8 hours for both resins. No significant differences in the removal efficiency for MN100 and MN200 resins were observed.

### Example 15

### Effect of pH on the Removal of BPA

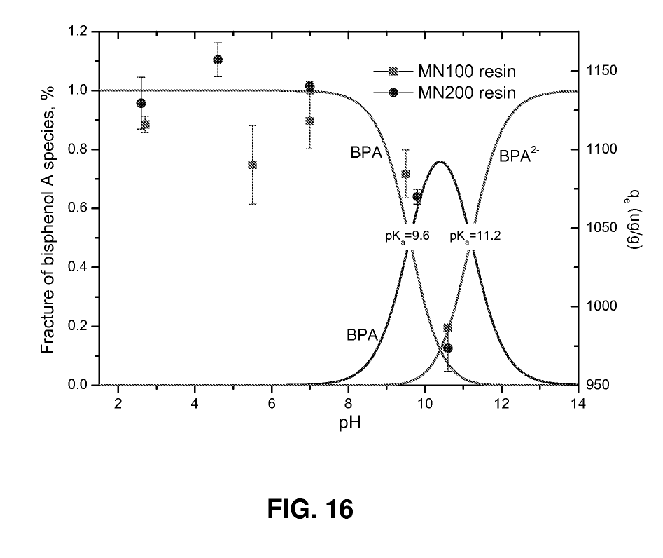

We tested the effect of pH on efficiency of estrogen removal as described in Example 1 and as follows: initial concentration=128.17 μg/L, contact time=24 hours, sample volume=1000 ml, temp=295 K, resin dosage=0.2 g/L. The results of this experiment are shown in FIG. 16. The amount of BPA adsorbed onto the resins decreased as the pH increased. At pH 3, the adsorption capacity for MN100 and MN200 resins was 1115.92 μg/g and 1129.44 μg/g, respectively. The adsorption capacities of both resins at low pH were similar. No significant changes were observed with either resin until the solution pH approached the pKa value of BPA. At pH 11, which is above the pKa value of BPA, the amount of BPA adsorbed onto the MN 100 and MN 200 resins dropped to 987 μg/g and 974 μg/g, respectively. Above pH 9, the adsorption capacity of the MN100 resin was higher than that of the MN200 resin. At pH, above 9, BPA molecules will ionize, and the charged species may undergo an ion-exchange process with the tertiary ammonium functional group in MN100 resin which may account for the relatively higher adsorption capacity relative to the MN200 resin.

### Example 16

### Effect of Ionic Strength on the Removal of BPA

In order to investigate the effects of ionic strength, the adsorption kinetics of BPA onto MN100 resin were studied under different NaCl concentrations (25, 100 and 800 mg/L). The results are shown in Table 3. No significant differences were observed at higher NaCl concentrations over 25 mg/L. A slight decrease in the pseudo-first-order rate constants was observed. The decrease of k1 may reflect that a small quantity of ions could compete with BPA at the active sites of MN100 resin and thus decrease the adsorption rate.

TABLE 3
Effect of ionic strength on the adsorption of BPA on to MN 100 resin

| | NaCl | qₑ (exp) | qₑ (cal) | k₁ | |
|---|---|---|---|---|---|
| Resin | (mg/L) | (μg/g) | (μg/g) | (h⁻¹) | R² |
| MN 100 | 0 | 1008.5 | 1028.6 | 0.21 | 0.95 |
| | 25 | 1036.8 | 1053.0 | 0.16 | 0.99 |
| | 100 | 1037.2 | 1043.8 | 0.15 | 0.99 |
| | 800 | 1051.4 | 1125.4 | 0.12 | 0.94 |

### Example 17

### Regeneration Test

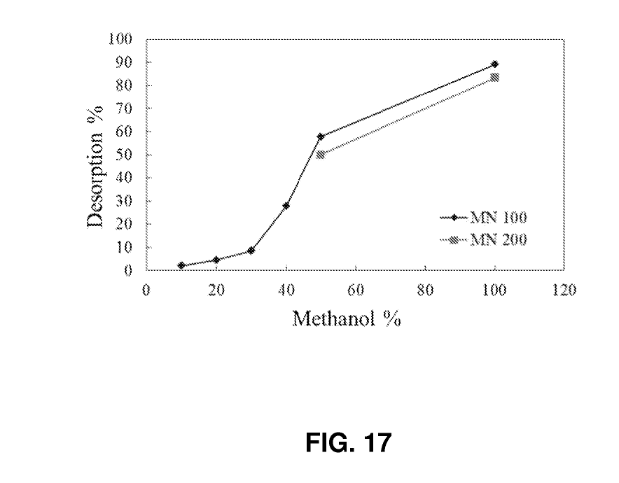

We analyzed the ability of MN 100 and MN 200 to be regenerated after use. Different amounts of methanol were mixed with deionized (DI) water to form a series of regeneration solutions. Binding conditions were as follows: contact time=24 hours, regeneration solution volume=100 ml, temperature=295 K, resin dosage=0.3 g/L. The results of regeneration tests for MN100 and MN200 resins exhausted by BPA are shown in FIG. 17. The recovery percentage of MN100 and MN200 resins by using pure methanol was 89% and 83%, respectively after 24 hours of mechanical shaking. The highest recovery percentages were obtained using pure methanol.

### Example 18

### Screening Various Polymeric Resins for 1,4-Dioxane Adsorption

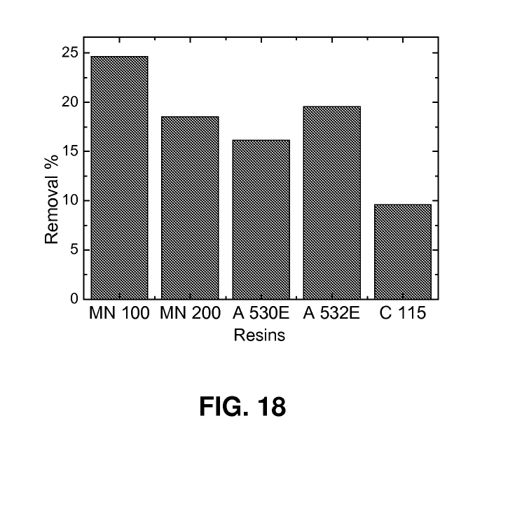

Resins MN100, MN200, A530E, A532E and C115 were assayed for the ability to adsorb 1,4-dioxane as described in Example 1 in batch mode. Binding conditions were: Initial concentration=125.87 μg/L, pH=7.0, contact time=48 hours, sample volume=1000 ml, temp=295 K, resin dosage=0.3 g/L. As shown in FIG. 18, all the resins removed less than 30% of 1,4-dioxane. The poor adsorption of 1,4-dioxane was likely due to its higher water solubility, suggesting that physical adsorption may be inefficient for removal. Ion-exchange type adsorption may be inefficient as well because 1,4-dioxane did not ionize under normal experimental conditions.

### Example 19

### Adsorption Capacity of MN100 and MN200 for 17β-Estradiol (E2) and 17α-Estradiol (EE2)

Adsorption capacity of MN100 and MN200 for 17β-Estradiol (E2) and its isomer, 17α-Estradiol (EE2) was calculated at an equilibrium concentration of 0.006 umol/L. Both compounds have same molecular weight and chemical formula. As shown in Table 4, MN100 resin had a higher adsorption capacity than MN200 resin for both E2 and EE2. MN100 also showed higher total adsorption capacity (15.8 umol/g) than MN200 (12.9 umol/g) for 12 hormone compounds in multi-component system, for equilibrium concentration of 0.006 umol/L of each compound.

TABLE 4
Adsorption capacity of MN100 and MN200

| | MN 100 | MN 200 |
|---|---|---|
| Adsorption | 1.54 | 0.48 |
| capacity | | |
| for E2 (umol/g) | | |
| Adsorption | 0.67 | 0.41 |
| capacity for EE2 | | |
| (umol/g) | | |

### Example 20

### Boron Removal Isotherm Studies

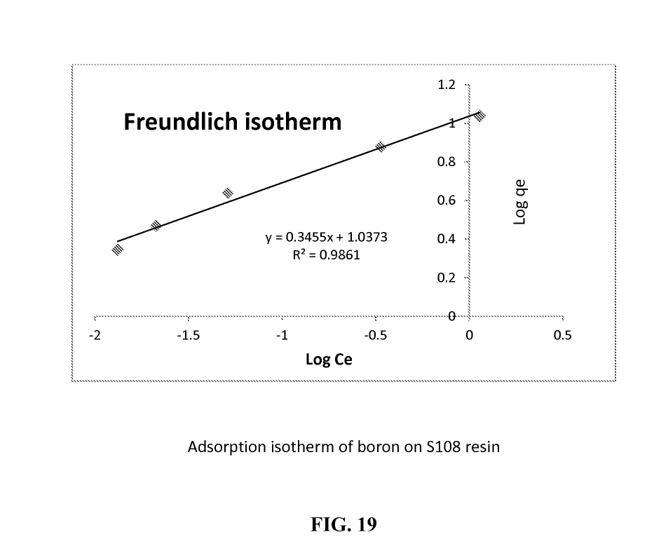

The S110 resin was assayed for its ability to remove boron. The boron removal was studied at 2 mg/L of initial concentration of boron in water. The adsorption studies were carried out by using S110 resin. The adsorption experimental results showed that S110 resin is a potential candidate for boron removal. The isotherm results are presented in FIG. 19. At 1 g/L resin dosage and over 99% removals was noted. The Freundlich isotherm studies were done. Generally, the Freundlich constant, “n” should have values lying in the range of 1 to 10 for classification as favorable adsorption. The Freundlich constant, “n” was found to be 2.9 which indicate the degree of favorability of boron adsorption. These isotherm studies demonstrate that S108 resin is effective for boron removal from water.

### Example 21

### Boron Removal in Fixed-Bed Column

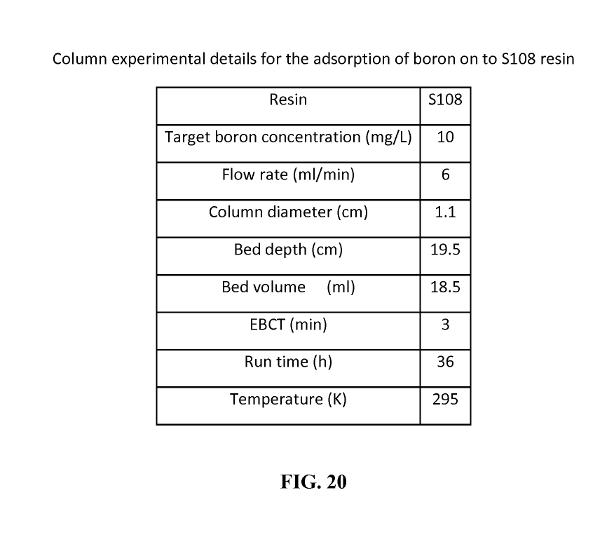

The resin was assayed in a fixed-bed column format to verify the performance of the S108 resin for boron removal in practical use. The main column conditions are summarized in the table shown in FIG. 20.

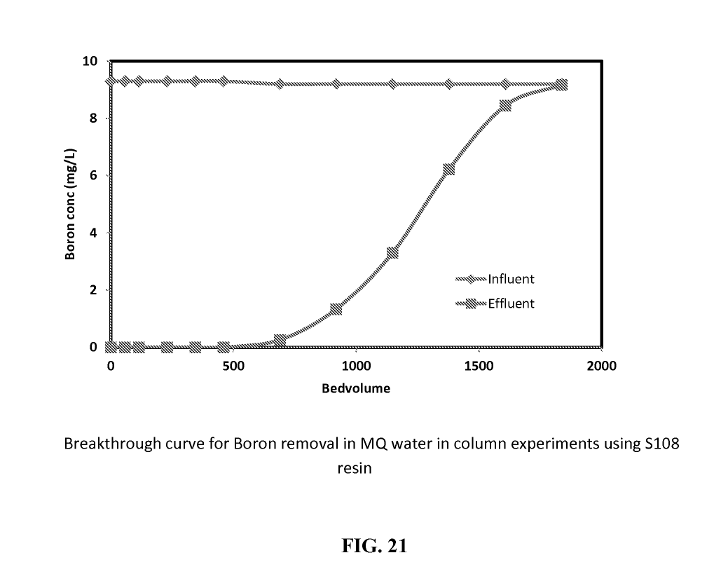

As seen in FIG. 21, the column format results showed that boron was successfully adsorbed on S108 resin and the breakthrough occur around 500 bed volumes. When a solute is continuously pumped through a column, it will start to elute at a certain volume, this is the breakthrough volume. The influent solution is relatively high in concentration of the species to be removed. The effluent solution is relatively low in species to be removed, as the resin was very efficient at removal of the species. At the breakthrough volume, this represents the point at which the column is no longer able to remove the species from the influent solution.

### Example 22

### Polyfluorocarbon (PFCs) Removal Isotherm Studies

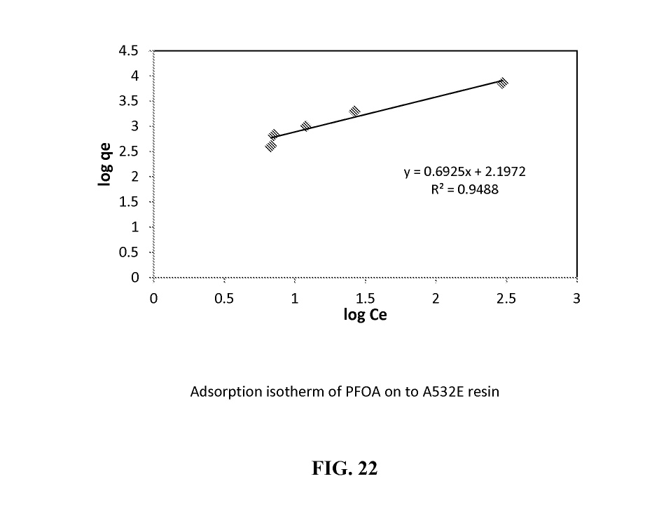

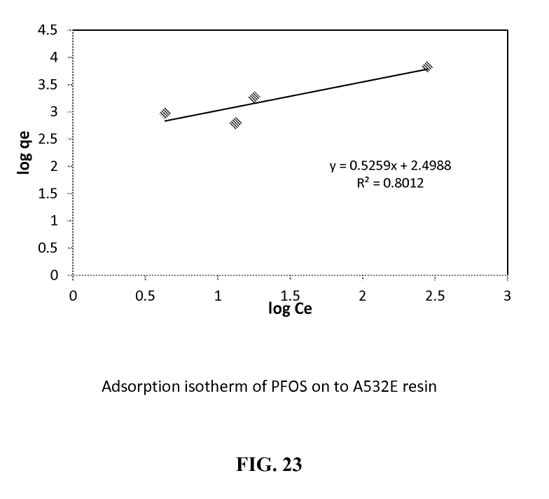

The A532E resin was assayed for its ability to remove PFOA and PFOS using isotherm studies. The isotherm studies were performed as a single component with 1 mg/L of initial concentration. The Freundlich isotherm results of PFOA and PFOS are presented in FIGS. 22 and 23, respectively. The results showed that A532E resin surprisingly removed both PFOA and PFOS. The Freundlich constant, “n” was found to be 1.44 and 1.90 for PFOA and PFOS, respectively which indicated the degree of favorability of removal of both compounds. These isotherm studies indicate that A532E resin effectively removed both PFOA and PFOS from an aqueous solution.

### Example 23

### Polyfluorocarbon (PFCs) Removal Fixed Bed Column Analysis

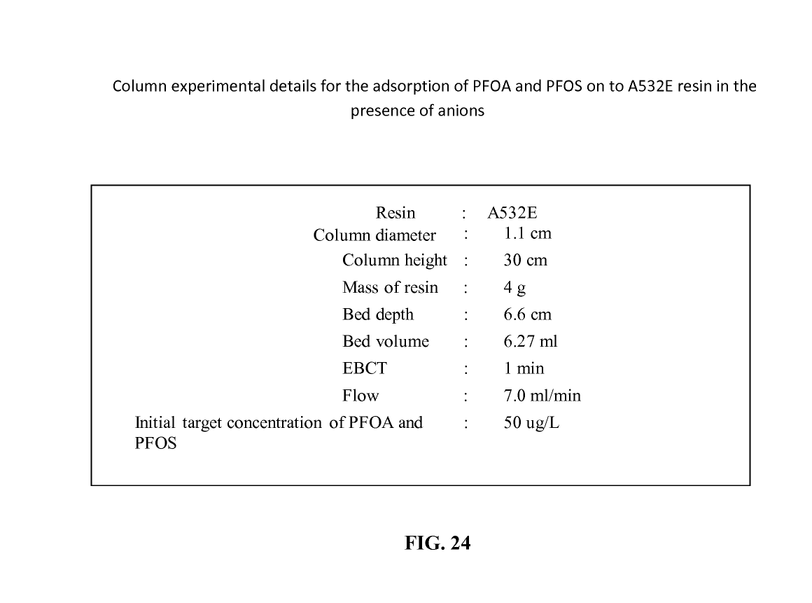

The A532E resin was assayed in column format for the removal of PFCs. The fixed-bed column experiment was conducted using a mixture of PFOA and PFOS, each at a concentration of 50 μg/L in water. The main column conditions are summarized in the table shown in FIG. 24.

The column experimental results are presented in FIG. 22. The results showed that there was no breakthrough occurs in 70 hrs run time. Since there was no breakthrough noted after passing 4750 bed volumes (70 hrs) in column experiments, the experiments were continued up to 33,000 bed volumes and the results are presented in FIG. 23. The figure clearly indicated that there was no breakthrough occurs even after passing 33,000 bed volumes through the column, suggesting that the resin had a high absorption capacity for PFOA and PFOS.

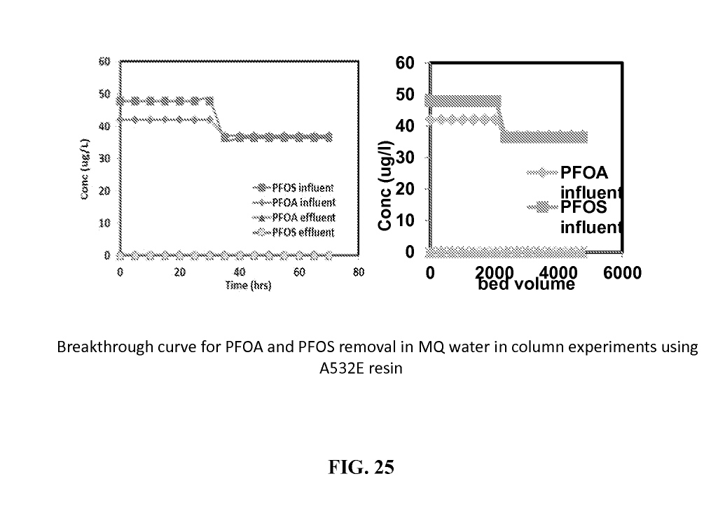

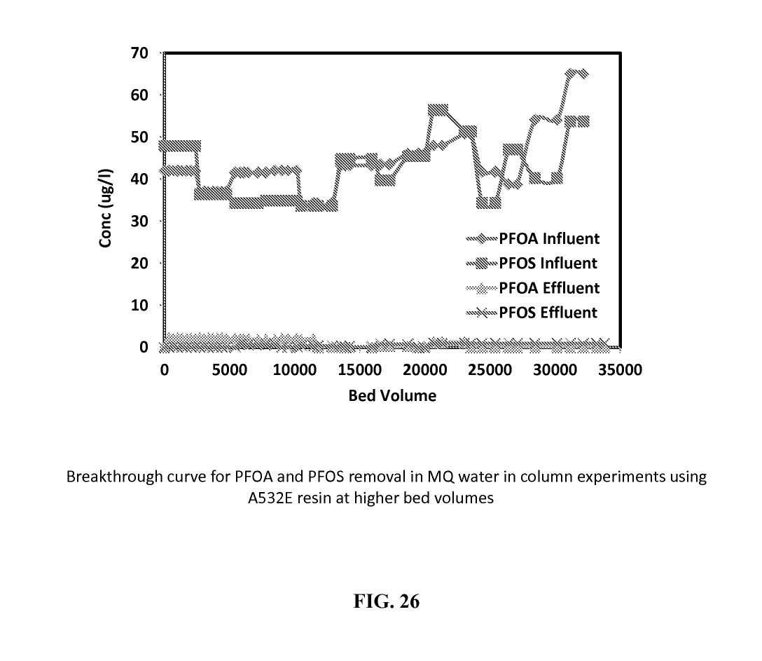

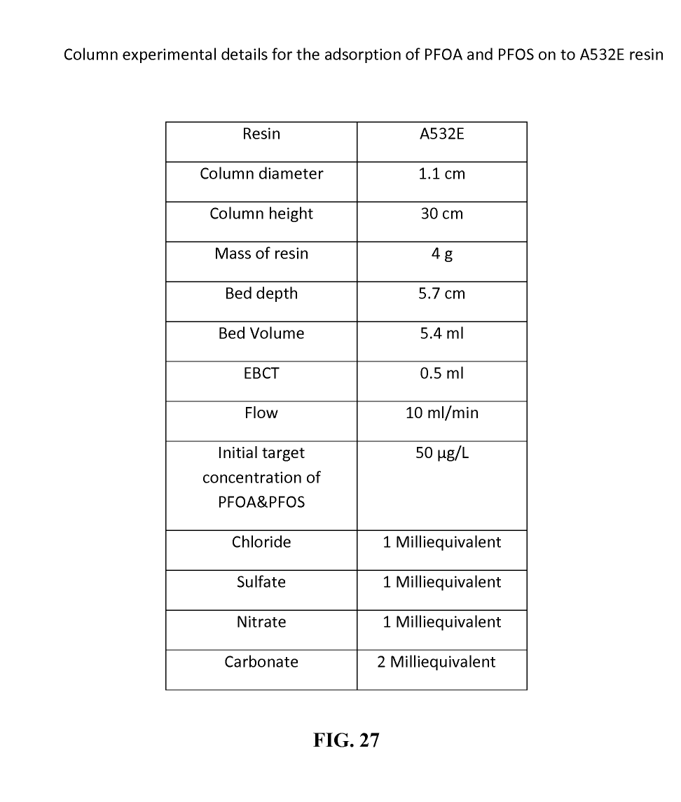

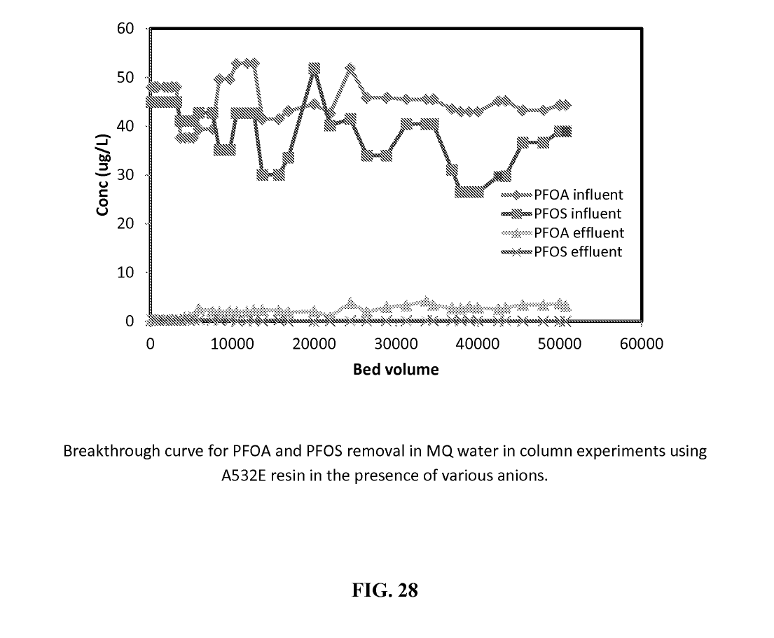

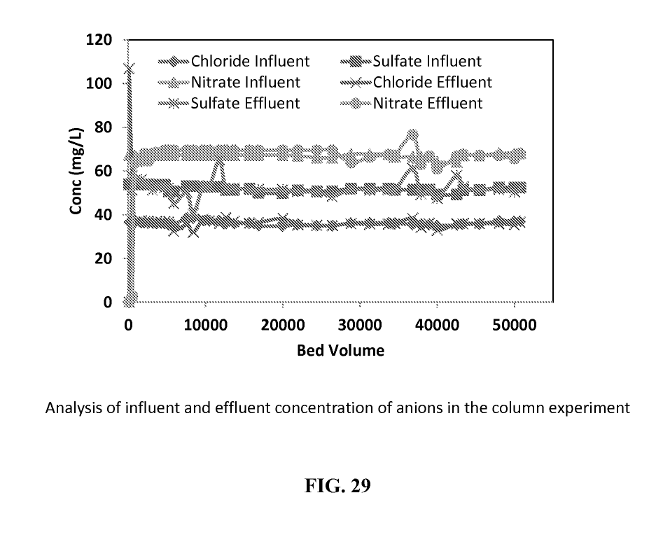

The column experiment was also conducted in the presence of other anions such as chloride, nitrate, sulfate and carbonate with a PFOA and PFOS mixture. The column experimental details are presented in the table shown in FIG. 27. As described in the table shown in FIG. 24, the column experiment was performed with 1 milli-equivalent of chloride, sulfate, nitrate and 2 milli-equivalents of carbonate ions while keeping the initial concentration of PFOA and PFOS for 50 μg/L. The PFOA and PFOS breakthrough curve is presented in FIG. 25. The results showed that there was no breakthrough occurs after passing 50,000 bed volumes which clearly indicated that the presence of anions in didn't influence the PFOA and PFOS adsorption. The concentration of anions in the influent and effluent was analyzed by Ion chromatography (IC) except carbonate and the results are presented in FIG. 26. Initially, higher chloride and lower nitrate, sulfate concentration were noted in the effluent samples compared to the influent concentration. Since the A532E resins present in chloride form there is a possibility of ion exchange of chloride with nitrate and sulfate ions. Due to the abovementioned reason higher chloride concentration and lower sulfate and nitrate concentrations were noted in the effluent samples initially. After 8 hours (840 bed volumes) the concentrations of these anions in the influent and effluent were similar which indicated that there was no further ion exchange of chloride ions with nitrate and sulfate ions.

A dosage of 0.05 g/L was needed to remove 100% of perfluorooctanoic acid (PFOA) in both resins (A530E and A532E) with the initial concentration of 50 μg/L. Furthermore, all three resins (A530E, A532E and MN100) could remove PFOA and reach the equilibrium within 20 hours. Both A530E and A532E resins did not reach the equilibrium capacity by increasing the PFOA concentration from 100 μg/L to 900 μg/L, meanwhile, MN100 resin reached the saturation status.

The influence of anions on the removal of PFOA and PFOS in a column format resulted in the surprising discovery that the presence of chloride, nitrate, sulfate and carbonate anions did not influence the adsorption of either PFOA or PFOS as there was no breakthrough observed after passing 50,000 bed volumes.

What is claimed is:

1. A method of reducing the concentration of an endocrine disrupting agent in an aqueous solution, the method comprising:
(a) providing an aqueous solution;
(b) contacting the aqueous solution with a polymeric resin in an amount and for a time sufficient to substantially bind the agent to the resin.

2. The method of claim 1, further comprising the step of separating the contacted aqueous solution from the polymeric resin.

3. The method of claim 1, wherein the aqueous solution comprises waste water.

4. The method of claim 1, wherein the endocrine disrupting agent is an estrogen, a perfluorinated compound, or bisphenol A.

5. The method of claim 4, wherein the estrogen is selected from the group consisting of 17α-ethynyl estrodiol, estriol, 17β-estrodiol, 17α-estrodiol, estrone, 17α-dihydroequilin, trimegestone, medrogestone, progesterone, norgestrel, gestodene, and equilin.

6. The method of claim 4, wherein the perfluorinated compound is selected from the group consisting of perfluorotridecanoic acid, tricosafluorododecanoic acid, perfluoroundecanoic acid, perfluorodecanoic acid, perfluorooctanoic acid tridecafluorononanoic acid, perfluoroheptanoic acid, undecafluorohexanoic acid heptadecafluorooctanesulfonic acid potassium salt, and tridecafluorohexane-1-sulfonic acid potassium salt.

7. The method of claim 4, wherein the endocrine disrupting agent is bisphenol A.

8. The method of claim 4, wherein the aqueous solution comprises an ionic salt.

9. The method of claim 8, wherein the ionic salt is selected from the group consisting of salts of chloride, nitrate, sulfate, and carbonate.

10. The method of claim 9, wherein the concentration of the chloride, nitrate, or sulfate salt is less than about 50 ng/L and the concentration of the carbonate salt is less than about 100 ng/L.

11. The method of claim 1, wherein the concentration of the endocrine disrupting agent in the aqueous solution is from about 1 ng/L to about 1000 ug/L.

12. The method of claim 11, wherein the concentration of the endocrine disrupting agent in the aqueous solution is from about 1 ug/L to about 500 ug/L.

13. The method of claim 12, wherein the concentration of the endocrine disrupting agent in the aqueous solution is about 100 ug/L.

14. The method of claim 1, wherein the polymeric resin comprises a macroporous resin, a microporous resin or an adsorbent, or a combination thereof.

15. The method of claim 14, wherein the polymeric resin comprises a mean pore diameter (D₅₀) of about 15 Å to about 1000 Å.

16. The method of claim 1, wherein the polymeric resin comprises an ion exchange resin.

17. The method of claim 16, wherein the ion exchange resin is selected from the group consisting of a weak base anion exchange resin, a strong base anion exchange resin, a weak acid anion exchange resin, a strong acid anion exchange resin.

18. The method of claim 16, wherein the ion exchange resin comprises a functional group selected from the group consisting of a tertiary amine, a quaternary ammonium group, a bifunctional quaternary amine, N-methylglucamine, and a carboxylic acid or salt thereof.

19. The method of claim 1, wherein the polymeric resin comprises a polystyrene matrix.

20. The method of claim 1, wherein the polymeric resin comprises a polymethacrylic matrix.

21. The method of claim 1, wherein the polymeric resin comprises a bead.

22. The method of claim 1, wherein contacting comprises flowing the aqueous solution through a packed bed comprising the polymeric resin.

23. The method of claim 22, wherein the flow rate is from about 3 mL/min to about 50 mL/min.

24. The method of claim 1, where in the contacting time is from about 8 hours to about 60 hours.

25. The method of claim 24, wherein the contacting time is about 48 hours.

26. The method of claim 1, wherein the temperature of the resin is about 20° C. to about 40° C.

27. The method of claim 1, wherein the concentration of the endocrine disrupting agent is reduced to less than about 1 part per billion (ppb) to less than about 100 parts per million (ppm).

28. The method of claim 27, wherein the concentration of the endocrine disrupting agent is reduced to less than about 1 part per billion (ppb) to less than about 1 part per million (ppm).

29. A method of reducing the concentration of an endocrine disrupting agent in an aqueous solution, the method comprising:
(a) providing an aqueous solution;
(b) contacting the aqueous solution with a polymeric resin in an amount and for a time sufficient to substantially adsorb the agent to the resin.

30. The method of claim 29, further comprising the step of separating the contacted aqueous solution from the polymeric resin.
